(19) United States
(12) Patent Application Publication
(10) Pub. No.: US 2023/0399129 A1
(43) Pub. Date: Dec. 14, 2023

(54) LIQUID LEVEL CONTROL APPARATUS, MOVING BODY, LIQUID LEVEL CONTROL METHOD, AND STORAGE MEDIUM

(71) Applicant: TOYOTA JIDOSHA KABUSHIKI KAISHA, Toyota-shi (JP)

(72) Inventor: Kotaro NAKAYAMA, Toyota-shi (JP)

(21) Appl. No.: 18/330,427

(22) Filed: Jun. 7, 2023

(30) Foreign Application Priority Data
Jun. 13, 2022 (JP) 2022-095252

(51) Int. Cl. B64G 1/54; G05D 9/00

(52) U.S. Cl. CPC B64G 1/54; G05D 9/00

(57) ABSTRACT

A liquid level control apparatus includes a reception unit that receives information relating to an incoming direction of radiation; and a liquid control unit that controls, based on the received information relating to the incoming direction, liquid levels in a plurality of tanks that are provided around a device and that store a liquid, so that the liquid level in a tank positioned in the incoming direction relative to the device rises.

### CROSS-REFERENCE TO RELATED APPLICATION

This application is based on and claims priority under 35 USC 119 from Japanese Patent application No. 2022-095252 filed on Jun. 13, 2022, the disclosure of which is incorporated by reference herein.

### BACKGROUND

### Technical Field

The present disclosure relates to a liquid level control apparatus, a moving body, a liquid level control method, and a non-transitory storage medium that stores a liquid level control program.

### Related Art

Japanese Patent application Laid-open (JP-A) No. 2016-173245 discloses a radiation shield cooling system that protects devices from radiation when a severe accident occurs at a nuclear power plant. In this radiation shield cooling system, the devices are disposed in a space inside a watertight container. When a severe accident occurs, cooling water is supplied to the watertight container, whereby the devices are protected from radiation. The radiation shield cooling system has a configuration where the devices are surrounded by water on all sides.

In this connection, it is known that the amount of radiation from sunlight at the lunar surface is greater than the amount of radiation from sunlight on Earth. For this reason, devices installed in a rover that travels on the lunar surface need to be radiation-resistant or protected.

However, a configuration where a shielding material such as lead is always provided around the devices and a configuration where, as in the technology disclosed in JP-A No. 2016-173245, a single container that surrounds all sides of the devices is filled with water increase the weight of a rover. The mass of a rover that travels on the lunar surface is directly linked to launch costs and mission feasibility, so the radiation shield cooling system disclosed in JP-A No. 2016-173245 has room for improvement in terms of mass.

### SUMMARY

In consideration of the above circumstances, the present disclosure provides a liquid level control apparatus that may protect devices from radiation with a lightweight structure, a moving body, a liquid level control method, and a non-transitory storage medium that stores a liquid level control program.

A first aspect of the disclosure is a liquid level control apparatus including: a reception unit that receives information relating to an incoming direction of radiation; and a liquid level control unit that controls, based on the received information relating to the incoming direction, liquid levels in plural tanks, which are provided around a device and may store a liquid, so that the liquid level in a tank positioned in the incoming direction relative to the device rises.

According to the first aspect, the information relating to the incoming direction of the radiation is received by the reception unit. Based on this information relating to the incoming direction, the liquid levels in the plural tanks provided around the device are controlled by the liquid level control unit.

Here, the liquid levels in the plural tanks are controlled so that the liquid level in the tank positioned in the incoming direction relative to the device rises. Since the radiation is shielded by the liquid inside the tank, when the liquid level in the tank positioned in the incoming direction relative to the device rises, shielding of the radiation relative to the device is enhanced. In this way, by controlling the liquid levels in the plural tanks provided around the device, shielding may be selectively enhanced relative to the incoming direction of the radiation as needed. Therefore, compared with a structure that always shields all sides of the device, the device may be protected from the radiation with a lightweight structure.

A second aspect of the disclosure is the first aspect, wherein the liquid level control unit performs a process to transfer liquid from another tank to the tank positioned in the incoming direction among the plural tanks which are communicated to each other by pipes.

According to the second aspect, the liquid is transferred to the tank positioned in the incoming direction from another tank among the plural tanks which are communicated to each other by the pipes. In other words, the liquid is transferred between the plural tanks. Therefore, compared with a configuration that supplies the liquid from a separate tank to each of the plural tanks, the device may be protected from the radiation with a simple configuration.

A third aspect of the disclosure is the second aspect, wherein the reception unit further receives information relating to the liquid levels in the plural tanks, and the liquid level control unit performs a process to not move the liquid stored in the plural tanks in a case in which the liquid level in the tank positioned in the incoming direction relative to the device among the plural tanks is equal to or higher than a standard liquid level and transfer the liquid from another tank to the tank positioned in the incoming direction among the plural tanks in a case in which the liquid level of the tank positioned in the incoming direction relative to the device is lower than the standard liquid level.

According to the third aspect, the information relating to the liquid levels in the plural tanks is received by the reception unit. In a case in which the liquid level in the tank positioned in the incoming direction relative to the device is equal to or higher than the standard liquid level, the liquid stored in the plural tanks is not moved. In a case in which the liquid level in the tank positioned in the incoming direction relative to the device is less than the standard liquid level, the liquid is transferred to the tank positioned in the incoming direction from another tank through the pipes. The standard liquid level is a predetermined liquid level set beforehand to obtain a predetermined protective effect in consideration of the size of the devices and the positional relationship between the devices and the tanks for example. According to this disclosure, only in a case in which the liquid level in the tank positioned in the incoming direction is insufficient for obtaining the predetermined protective effect is the liquid transferred to the tank. Thus, energy consumption pertaining to transfer is inhibited.

A fourth aspect of the disclosure is the third aspect, wherein the liquid level control unit performs a process to transfer, in a case in which there are multiple tanks positioned in the incoming direction relative to the device, the liquid to at least one of the tanks positioned in the incoming direction.

According to the fourth aspect, the liquid is transferred to at least one of the multiple tanks positioned in the incoming direction. Because of this, the radiation may be attenuated even in case in which the radiation is coming from a direction straddling the multiple tanks.

A fifth aspect of the disclosure is the fourth aspect, wherein the liquid level control unit performs a process to transfer the liquid such that, among the multiple tanks positioned in the incoming direction, the tank that may shield the radiation in a wider range relative to the device is given priority.

According to the fifth aspect, the liquid is transferred such that, among the multiple tanks positioned in the incoming direction, the tank that may shield the radiation in a wider range relative to the device is given priority. Thus, the device may be efficiently protected from the radiation early on. Furthermore, even in a case in which there is not enough of the liquid, the device may be efficiently protected by an optimum arrangement of the liquid.

A sixth aspect of the disclosure is the fourth aspect, wherein the liquid level control unit performs a process to transfer the liquid so that the liquid levels in all the multiple tanks positioned in the incoming direction become equal to or higher than the standard liquid level.

According to the sixth aspect, if the liquid levels in the plural tanks positioned in the incoming direction are all equal to or higher than the standard liquid level, the liquid is not moved, and in a case in which the liquid level in at least one of the multiple tanks positioned in the incoming direction is less than the standard liquid level, the liquid is transferred to the tank whose liquid level is lower than the standard liquid level so that the liquid levels in all the tanks positioned in the incoming direction become equal to or higher than the standard liquid level. Thus, shielding relative to the device is improved even more.

A seventh aspect of the disclosure is a moving body including: the liquid level control apparatus of any one of the first aspect to the sixth aspect; the device; and the plural tanks.

According to the seventh aspect, the plural tanks that may store the liquid are provided around the device. First, the information relating to the incoming direction of the radiation is received by the reception unit of the liquid level control apparatus. Then, based on this information relating to the incoming direction, the liquid levels in the plural tanks provided around the device are controlled by the liquid level control unit of the liquid level control apparatus.

Here, the liquid levels in the plural tanks are controlled so that the liquid level in the tank positioned in the incoming direction relative to the device rises. The radiation is shielded by the liquid inside the tank. Therefore, when the liquid level in the tank positioned in the incoming direction rises, shielding of the radiation relative to the device is enhanced.

In this way, by controlling the liquid levels in the plural tanks provided around the device, shielding may be selectively enhanced relative to the incoming direction of the radiation as needed. Therefore, compared with a structure that always shields all sides of the device, the device may be protected from the radiation with a lightweight structure.

An eighth aspect of the disclosure is a moving body including: the liquid level control apparatus of any one of the third aspect to the sixth aspect; direction sensors that may detect the incoming direction; the device; the plural tanks; liquid level sensors that may detect the liquid levels in the plural tanks; and liquid transfer apparatus that include the pipes and pumps and may transfer the liquid between the plural tanks.

According to the eighth aspect, the incoming direction of the radiation is detected by the direction sensors. Furthermore, the liquid levels in the plural tanks are detected by the liquid level sensors. Additionally, the information relating to the incoming direction of the radiation and the information relating to the liquid levels in the plural tanks are received by the reception unit of the liquid level control apparatus.

In a case in which the liquid level in the tank positioned in the incoming direction relative to the device is equal to or higher than the standard liquid level, the liquid stored in the plural tanks is not moved. In a case in which the liquid level in the tank positioned in the incoming direction relative to the device is less than the standard liquid level, the liquid is transferred to the tank positioned in the incoming direction from another tank by the liquid transfer apparatus equipped with the pipes and the pumps. According to this disclosure, only in a case in which the liquid level in the tank positioned in the incoming direction is insufficient for obtaining the predetermined protective effect is the liquid transferred to the tank. Thus, energy consumption may be inhibited. Furthermore, the liquid is transferred between the plural tanks. Therefore, compared with a configuration that supplies the liquid from a separate tank to each of the plural tanks, the device may be protected from the radiation with a simple configuration.

A ninth aspect of the disclosure is the eighth aspect, wherein the plural tanks are provided in end portions of a cabin, in which a plurality of the devices are installed, at least in directions in which the radiation may come relative to the plural devices.

According to the ninth aspect, the plural tanks are disposed in end portions of the cabin in directions in which the radiation may come. Therefore, the radiation coming from these directions is shielded by the plural tanks, and ingress of the radiation into the cabin space is inhibited. Thus, even in a case in which, for example, the plural devices are installed in the cabin, it is not necessary to provide a shielding member or a shielding apparatus for each of the devices, and the plural devices may be collectively protected.

A tenth aspect of the disclosure is the ninth aspect, wherein the cabin is configured to be able to accommodate an occupant.

According to the tenth aspect, the plural tanks are provided in end portions of the cabin in directions in which the radiation may come. Therefore, the radiation is shielded by the plural tanks, and the occupant inside the cabin may be protected from the radiation.

An eleventh aspect of the disclosure is the tenth aspect, wherein at least one of the plural tanks includes a discharge portion that may discharge the liquid to the outside of the tank.

According to the eleventh aspect, by using the liquid transfer apparatus to transfer the liquid to the tank provided with the discharge portion, the liquid stored in the plural tanks may be discharged from the discharge portion. Because of this, the liquid stored in the plural tanks may be utilized for purposes other than radiation shielding.

A twelfth aspect of the disclosure is the eleventh aspect, wherein the moving body is a rover that travels on the lunar surface.

According to the twelfth aspect, the liquid is stored in the plural tanks installed in the rover. Because the amount of radiation from sunlight at the lunar surface is greater than the amount of radiation from sunlight on Earth, the devices installed in the rover that travels on the lunar surface need to be radiation-resistant or protected. Furthermore, the mass of the rover that travels on the lunar surface is directly linked to launch costs and mission feasibility. According to this disclosure, by controlling the liquid levels in the plural tanks provided around the devices, shielding may be selectively enhanced relative to the incoming direction of the radiation as needed. For this reason, compared with a structure that always shields all sides of the devices, the devices may be protected from the radiation with a lightweight structure. Moreover, in a case in which, for example, water is stored in the tanks, the water may be utilized as domestic water for occupants. Thus, launch costs for a mission to explore the lunar surface may be reduced and mission feasibility may be improved.

A thirteenth aspect of the disclosure is the twelfth aspect, wherein the moving body is a rover that travels in the lunar polar regions, and the plural tanks include a front tank provided in a front end portion of the rover, a rear tank provided in a rear end portion of the rover, a left tank provided in a width direction left end portion of the rover, and a right tank provided in a width direction right end portion of the rover.

According to the thirteenth aspect, the radiation coming from the front side of the rover is shielded by the front tank provided in the front end portion of the rover. Furthermore, the radiation coming from the rear side of the rover is shielded by the rear tank provided in the rear end portion of the rover. Moreover, the radiation coming from the width direction left side of the rover is shielded by the left tank. Moreover, the radiation coming from the width direction right side of the rover is shielded by the right tank.

The solar elevation is low at the lunar polar regions and, therefore, the radiation is always incident from a horizontal direction relative to the rover. Thus, by providing the tanks in the front, rear, left, and right directions of the rover and controlling the liquid levels in each, the radiation is always shielded by any of the tanks even when the orientation of the rover relative to the sunlight changes. Consequently, compared with a structure where the tanks are provided on all sides of the devices, the devices may be protected with a lightweight structure.

A fourteenth aspect of the disclosure is a liquid level control method including: receiving information relating to an incoming direction of radiation; and controlling, based on the received information relating to the incoming direction, liquid levels in plural tanks, which are provided around a device and may store a liquid, so that the liquid level in a tank positioned in the incoming direction relative to the device rises.

According to the fourteenth aspect, the information relating to the incoming direction of the radiation is received. Based on this information relating to the incoming direction, the liquid levels in the plural tanks provided around the device are controlled. Here, the liquid levels in the plural tanks are controlled so that the liquid level in the tank positioned in the incoming direction relative to the device rises. The radiation is shielded by the liquid inside the tank, so when the liquid level in the tank positioned in the incoming direction rises, shielding of the radiation relative to the device is enhanced. In this way, by controlling the liquid levels in the plural tanks provided around the device, shielding may be selectively enhanced relative to the incoming direction of the radiation as needed. Therefore, compared with a structure that always shields all sides of the device, the device may be protected from the radiation with a lightweight structure.

A fifteenth aspect of the disclosure is a non-transitory storage medium in which is stored a program causing a computer to execute a liquid level control process, the liquid level control process including: receiving information relating to an incoming direction of radiation; and controlling, based on the received information relating to the incoming direction, liquid levels in plural tanks, which are provided around a device and may store a liquid, so that the liquid level in a tank positioned in the incoming direction relative to the device rises.

According to the fifteenth aspect, the information relating to the incoming direction of the radiation is received. Based on this information relating to the incoming direction, the liquid levels in the plural tanks provided around the device are controlled. Here, the liquid levels in the plural tanks are controlled so that the liquid level in the tank positioned in the incoming direction relative to the device rises. The radiation is shielded by the liquid inside the tank, so when the liquid level in the tank positioned in the incoming direction rises, shielding of the radiation relative to the device is enhanced. In this way, by controlling the liquid levels in the plural tanks provided around the device, shielding may be selectively enhanced relative to the incoming direction of the radiation as needed. Therefore, compared with a structure that always shields all sides of the device, the device may be protected from the radiation with a lightweight structure.

As described above, the liquid level control apparatus pertaining to the first aspect may protect the device from the radiation with a lightweight structure.

The liquid level control apparatus pertaining to the second aspect may protect the device with an even more lightweight structure.

The liquid level control apparatus pertaining to the third aspect may efficiently protect the device.

The liquid level control apparatus pertaining to the fourth aspect may attenuate the radiation even in a case in which the radiation is coming from a direction straddling multiple tanks.

The liquid level control apparatus pertaining to the fifth aspect may protect the device even more efficiently.

The liquid level control apparatus pertaining to the sixth aspect may improve shielding relative to the device even more.

The moving body pertaining to the seventh aspect may protect the device installed in the moving body from the radiation with a lightweight structure.

The moving body pertaining to the eighth aspect may efficiently protect the device with a simple configuration.

The moving body pertaining to the ninth aspect may widely shield the cabin interior.

The moving body pertaining to the tenth aspect may protect the occupant from the radiation.

The moving body pertaining to the eleventh aspect may utilize the liquid for purposes other than radiation shielding.

The moving body pertaining to the twelfth aspect may reduce launch costs for a mission to explore the lunar surface and improve mission feasibility.

The moving body pertaining to the thirteenth aspect may even further reduce launch costs for a mission to explore the lunar surface and even further improve mission feasibility.

The liquid level control method pertaining to the fourteenth aspect may protect the device from the radiation with a lightweight structure.

The non-transitory storage medium storing the liquid level control program pertaining to the fifteenth aspect may protect the device from the radiation with a lightweight structure.

### BRIEF DESCRIPTION OF THE DRAWINGS

FIG. 1 is a schematic plan view showing the arrangement of tanks and devices inside a rover in which a liquid level control apparatus pertaining to an embodiment is installed;

FIG. 2 is a block diagram showing hardware configurations of a liquid level control system including the liquid level control apparatus shown in FIG. 1;

FIG. 3 is a block diagram showing functional configurations of the liquid level control apparatus shown in FIG. 1;

FIG. 4 is a flowchart showing an example of the flow of a radiation inhibition process executed by a CPU shown in FIG. 2;

FIG. 5A is a drawing describing a case in which sunlight is incident from the front side of the rover shown in FIG. 1, and illustrates the orientation of the rover relative to the sunlight;

FIG. 5B is a sectional view, seen from the rear side of the rover, obtained by cutting the rover along line X-X of FIG. 1, and describes water transfer in the case shown in FIG. 5A;

FIG. 6A is a drawing describing a case in which sunlight is incident from the left side of the rover shown in FIG. 1, and shows the orientation of the rover relative to the sunlight;

FIG. 6B is a sectional view, seen from the right side of the rover, obtained by cutting the rover along line Y-Y of FIG. 1, and describes water transfer in the case shown in FIG. 6A;

FIG. 7A is a drawing describing a case in which sunlight is incident from the left front side of the rover shown in FIG. 1, and is a sectional view, seen from the rear side of the rover, obtained by cutting the rover along line X-X of FIG. 1; and

FIG. 7B is a sectional view, seen from the right side of the rover, obtained by cutting the rover along line Y-Y of FIG. 1.

### DETAILED DESCRIPTION

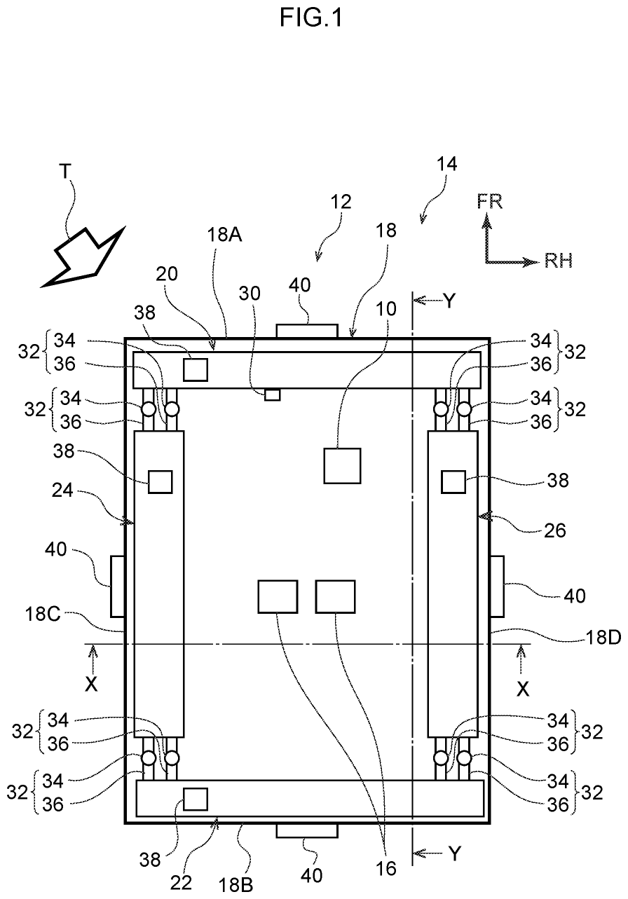

A rover 14, in which a liquid level control system 12 including a liquid level control apparatus 10 pertaining to an embodiment of the present disclosure is installed, will be described below using FIG. 1 to FIG. 7B. It will be noted that arrow FR, arrow UP, arrow LH, and arrow RH shown in the drawings indicate a forward direction, an upward direction, a leftward direction in a left and right direction (width direction), and a rightward direction in the left and right direction (width direction) of the rover 14, respectively. Furthermore, when the directions of front/rear, up/down, left/right, and inside/outside are used without further specification in the following description, these will be understood to mean front/rear in the rover front and rear direction, up/down in the rover up and down direction, left/right in the rover left and right direction (width direction), and inside/outside a cabin of the rover. Below, the overall configuration of the rover 14 will be described, and then the liquid level control apparatus 10 will be described in detail.

### (Overall Configuration of Rover 14)

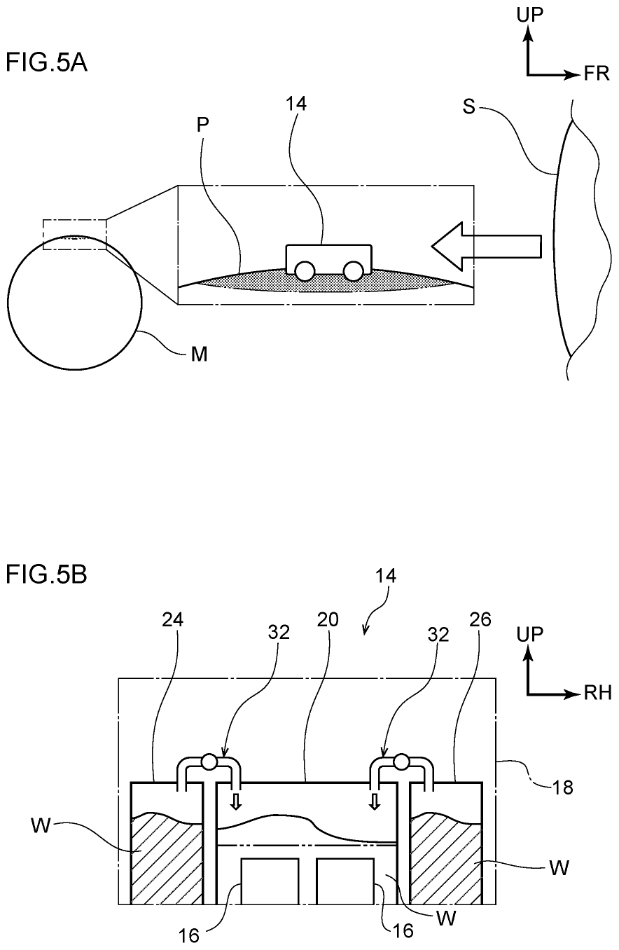

FIG. 1 shows a schematic plan view of the rover 14, which serves as a moving body in which the liquid level control apparatus 10 pertaining to this embodiment is installed. The rover 14 is a manned, pressurized lunar surface rover used in a mission to explore the polar regions P of the moon M (hereinafter called the “lunar polar regions P”) (see FIG. 5A).

The rover 14 includes, in a width direction middle area and a front and rear direction middle area thereof, two semiconductor devices 16 serving as devices. It will be noted that the number and arrangement of the semiconductor devices 16 are not limited to the above.

The rover 14 includes a cabin 18 that may accommodate a crew serving as occupants (not shown in the drawings). Inside the cabin 18 of the rover 14, a front tank 20 is provided in the front end portion and a rear tank 22 is provided in the rear end portion. Also inside the cabin 18, a left tank 24 is provided in the left end portion and a right tank 26 is provided in the right end portion.

The front tank 20, the rear tank 22, the left tank 24, and the right tank 26 are substantially cuboidal containers that may store water W (see FIG. 5B). The water W is stored in at least one of the front tank 20, the rear tank 22, the left tank 24, and the right tank 26. The water W is domestic water for the crew (not shown in the drawings) of the rover 14.

The front tank 20, the rear tank 22, the left tank 24, and the right tank 26 are arranged substantially in the shape of a rectangle as seen in plan view so as to surround the semiconductor devices 16. More specifically, the front tank 20 extends in the width direction and the up and down direction along a front wall portion 18A of the cabin 18. The rear tank 22 extends in the width direction and the up and down direction along a rear wall portion 18B of the cabin 18. The left tank 24 extends in the front and rear direction and the up and down direction along a left wall portion 18C of the cabin 18. The right tank 26 extends in the front and rear direction and the up and down direction along a right wall portion 18D of the cabin 18.

The front tank 20 includes a discharge portion 30 that may discharge the water W (see FIG. 5B) from the front tank 20. It will be noted that the discharge portion 30 is not limited to being provided in the front tank 20 and may be provided in the rear tank 22, the left tank 24, or the right tank 26. Furthermore, plural discharge portions 30 may be provided. For example, plural discharge portions 30 may be provided in the front tank 20. Furthermore, for example, discharge portions 30 may be provided in the front tank 20 and the rear tank 22.

The front tank 20 and the left tank 24 are interconnected by a pair of liquid transfer apparatus 32. Of the pair of liquid transfer apparatus 32, one liquid transfer apparatus 32 is configured such that it may transfer the water W (see FIG. 5B) from the front tank 20 to the left tank 24, and the other liquid transfer apparatus 32 is configured such that it may transfer the water W from the left tank 24 to the front tank 20.

Likewise, the front tank 20 and the right tank 26 are interconnected by a pair of liquid transfer apparatus 32. Of the pair of liquid transfer apparatus 32, one liquid transfer apparatus 32 is configured such that it may transfer the water W from the front tank 20 to the right tank 26, and the other liquid transfer apparatus 32 is configured such that it may transfer the water W from the right tank 26 to the front tank 20.

Likewise, the rear tank 22 and the left tank 24 are interconnected by a pair of liquid transfer apparatus 32. Of the pair of liquid transfer apparatus 32, one liquid transfer apparatus 32 is configured such that it may transfer the water W from the rear tank 22 to the left tank 24, and the other liquid transfer apparatus 32 is configured such that it may transfer the water W from the left tank 24 to the rear tank 22.

Likewise, the rear tank 22 and the right tank 26 are interconnected by a pair of liquid transfer apparatus 32. Of the pair of liquid transfer apparatus 32, one liquid transfer apparatus 32 is configured such that it may transfer the water W from the rear tank 22 to the right tank 26, and the other liquid transfer apparatus 32 is configured such that it may transfer the water W from the right tank 26 to the rear tank 22. It will be noted that the tanks are not limited to a configuration where adjacent tanks are interconnected by a pair of liquid transfer apparatus 32. For example, the front tank 20 and the rear tank 22 may be interconnected by a pair of liquid transfer apparatus 32. Furthermore, the liquid transfer apparatus 32 are not limited to being a pair and may, for example, be configured by one apparatus that may transfer a liquid in two directions.

Each liquid transfer apparatus 32 includes a pump 34 that may pump the water W (see FIG. 5B), a pipe 36 through which the water W is circulated, and a valve (not shown in the drawings). The front tank 20 and the left tank 24, the front tank 20 and the right tank 26, the rear tank 22 and the left tank 24, and the rear tank 22 and the right tank 26 are communicated to each other by the pipes 36. It will be noted that the configuration of the liquid transfer apparatus is not limited to the above.

Furthermore, the front tank 20, the rear tank 22, the left tank 24, and the right tank 26 are each provided with a water level sensor 38 serving as a liquid level sensor that may detect the level of the water W stored in the tank.

Moreover, the cabin outer sides of the front wall portion 18A, the rear wall portion 18B, the left wall portion 18C, and the right wall portion 18D of the rover 14 are each provided with a sun sensor 40 serving as a direction sensor. The sun sensors 40 are sensors that may detect the intensity and incoming direction of sunlight. The rover 14 includes the sun sensors 40 on each of the four surfaces outside the cabin, whereby the rover 14 is configured such that it may detect the incoming direction of the sunlight. It will be noted that the direction sensors are not limited to the sun sensors 40 described above; it suffices for them to be configured such that they may detect the incoming direction of radiation.

### (Liquid Level Control Apparatus 10)

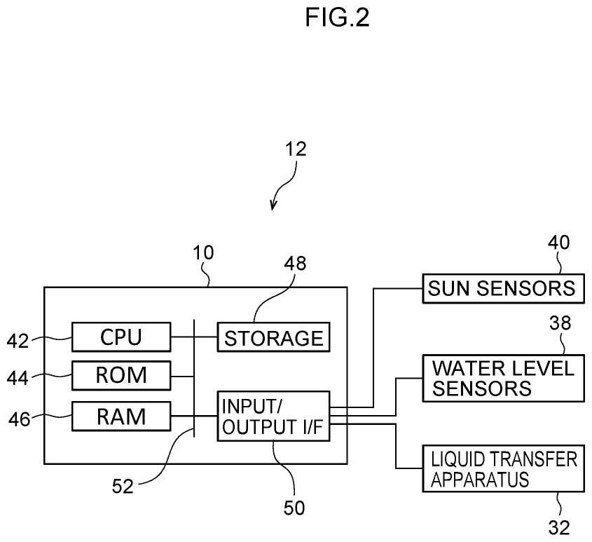

The rover 14 includes the liquid level control apparatus 10 that controls the water levels in each of the front tank 20, the rear tank 22, the left tank 24, and the right tank 26. First, hardware configurations of the liquid level control system 12 including the liquid level control apparatus 10 will be briefly described using FIG. 2.

The liquid level control apparatus 10 includes a central processing unit (CPU) 42, a read-only memory (ROM) 44, a random-access memory (RAM) 46, a storage 48, and an input/output interface (I/F) 50. These configurations are communicably connected to each other via a bus 52.

The CPU 42 is a central arithmetic processing unit, executes various types of programs, and controls each part of the liquid level control apparatus 10. That is, the CPU 42 reads programs from the ROM 44 or the storage 48 and executes the programs using the RAM 46 as a workspace. The CPU 42 controls each of the above configurations and performs various types of arithmetic processing in accordance with the programs stored in the ROM 44 or the storage 48.

The ROM 44 stores various types of programs and various types of data. The RAM 46 temporarily stores programs or data as a workspace. The storage 48 is configured by a hard disk drive (HDD) or a solid-state drive (SSD) and stores various types of programs and various types of data.

The input/output I/F 50 is electrically connected to the sun sensors 40, the water level sensors 38, and the liquid transfer apparatus 32.

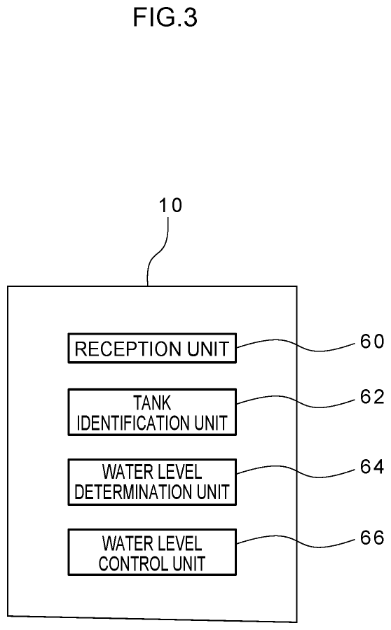

As shown in FIG. 3, the liquid level control apparatus 10 includes, as functional configurations, a reception unit 60, a tank identification unit 62, a water level determination unit 64, and a water level control unit 66. It will be noted that these functional configurations are realized as a result of the CPU 42 reading and executing a liquid level control program stored in the ROM 44.

The reception unit 60 receives from the four sun sensors 40 information relating to the intensity and incoming direction of the sunlight measured by each of the sun sensors 40. The reception unit 60 also receives from the four water level sensors 38 information relating to the water levels measured by each of the water level sensors 38 in the front tank 20, the rear tank 22, the left tank 24, and the right tank 26.

The tank identification unit 62 identifies which among the front tank 20, the rear tank 22, the left tank 24, and the right tank 26 is the tank positioned in the incoming direction of the radiation relative to the semiconductor devices 16 based on the information relating to the intensity and incoming direction of the sunlight measured by each of the sun sensors 40.

As an example, in a case in which, as shown in FIG. 5A, the sun S is positioned on the front side of the rover 14 traveling in the lunar polar regions P, the sunlight is coming from the front side relative to the rover 14. In this case, the tank identification unit 62 identifies the front tank 20 (see FIG. 1) as the tank positioned in the incoming direction.

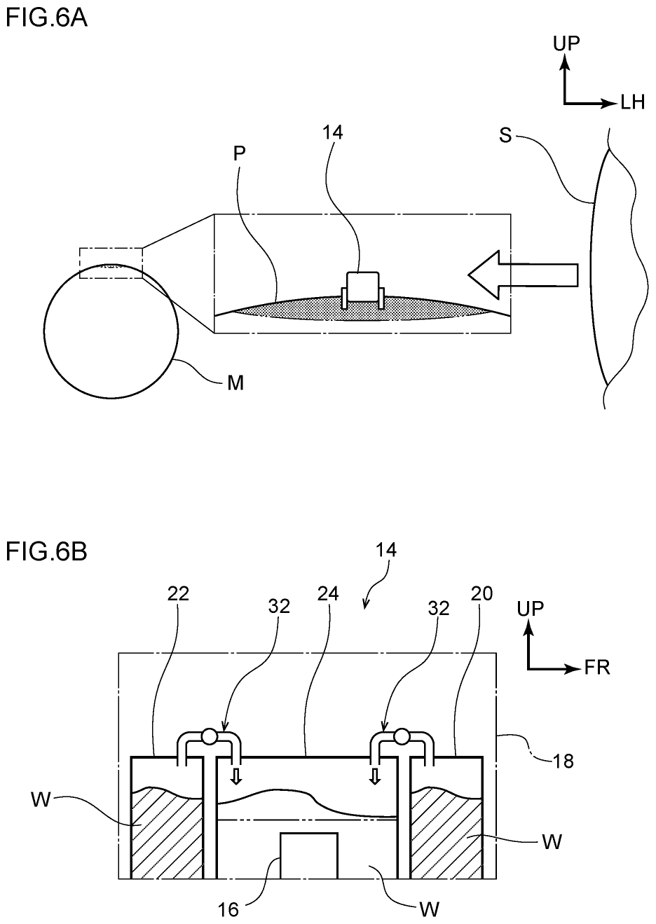

As another example, in a case in which, as shown in FIG. 6A, the sun S is positioned on the left side of the rover 14 traveling in the lunar polar regions P, the sunlight is coming from the left side relative to the rover 14. In this case, the tank identification unit 62 identifies the left tank 24 (see FIG. 1) as the tank positioned in the incoming direction.

As still another example, in a case in which, for example, the radiation is coming from the left front side of the rover 14 (from the direction of arrow T in FIG. 1), the tank identification unit 62 identifies the front tank 20 and the left tank 24 as the tanks positioned in the incoming direction.

The water level determination unit 64 determines whether or not the water level in the tank positioned in the incoming direction identified by the tank identification unit 62 is equal to or higher than a standard water level based on the information relating to the water levels in each of the front tank 20, the rear tank 22, the left tank 24, and the right tank 26 received by the reception unit 60.

The standard water levels in the front tank 20, the rear tank 22, the left tank 24, and the right tank 26 are predetermined water levels set beforehand as water levels that may shield the entireties of the two semiconductor devices 16 in consideration of the positional relationships between each tank and the two semiconductor devices 16, the incoming direction of the radiation, and the sizes of the semiconductor devices 16, for example.

The water level control unit 66 does not move the water W in a case in which the water level in the tank positioned in the incoming direction is equal to or higher than the standard water level based on the result determined by the water level determination unit 64.

In a case in which the water level in the tank positioned in the incoming direction is lower than the standard water level, the water level control unit 66 controls the pumps 34 and the valves (not shown in the drawings) of the liquid transfer apparatus 32 to control the water levels in the front tank 20, the rear tank 22, the left tank 24, and the right tank 26 so that the water level in the tank positioned in the incoming direction rises. As an example, in a case in which the radiation is coming from the front side of the rover 14, the water level control unit 66 operates the liquid transfer apparatus 32 that may transfer the water W from the left tank 24 to the front tank 20 and the liquid transfer apparatus 32 that may transfer the water W from the right tank 26 to the front tank 20 so that the water level in the front tank 20 positioned in the incoming direction rises as shown in FIG. 5B. It will be noted that the water level control unit 66 may also transfer the water W from just the left tank 24 or just the right tank 26 to the front tank 20.

The water level control unit 66 transfers the water W until the water level in the tank positioned in the incoming direction reaches a target water level. The target water level is, as an example, set higher than the standard water level, and is an arbitrary water level set beforehand as a water level that may sufficiently shield the entireties of the two semiconductor devices 16 even when the water level undulates because of the traveling of the rover 14, for example.

Here, in a case in which there are multiple tanks positioned in the incoming direction relative to the semiconductor devices 16, the water level control unit 66 performs a process to transfer the water W so that the water levels in all the multiple tanks positioned in the incoming direction become equal to or higher than the standard water level, provided that there is a sufficient volume of water. The water level control unit 66 also performs a process to transfer the liquid such that the tank that may shield the radiation in a wider range relative to the semiconductor devices 16 is given priority.

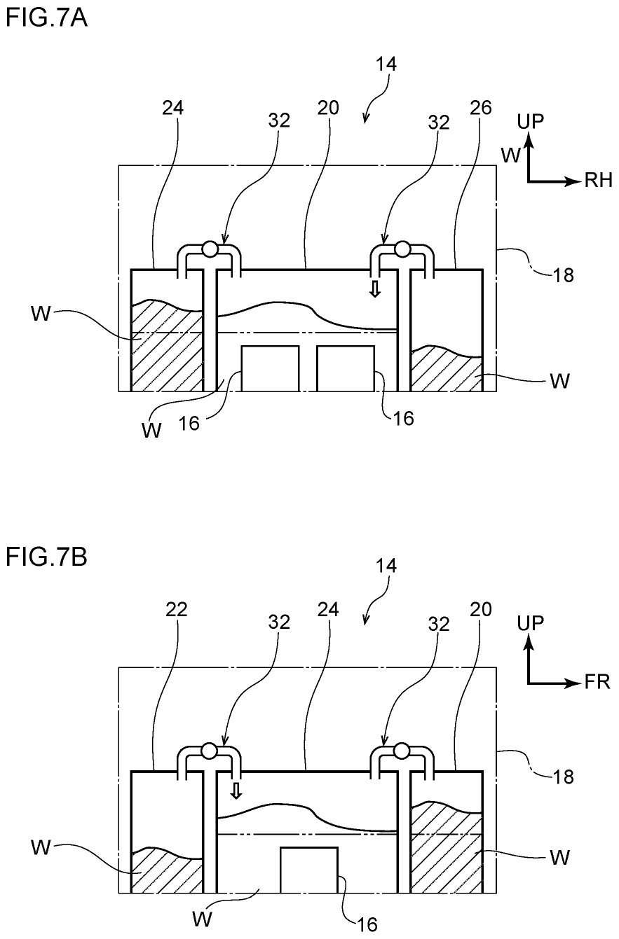

For example, in a case in which the radiation is coming from the left front side of the rover 14 (from the direction of arrow T in FIG. 1), the water level control unit 66 performs a process to transfer the water W to the front tank 20 and the left tank 24 so that the water levels in both the front tank 20 and the left tank 24 become equal to or higher than the standard water level as shown in FIG. 7A and FIG. 7B. Specifically, the water level control unit 66 performs a process to transfer the water W from the right tank 26 to the front tank 20 as shown in FIG. 7A and performs a process to transfer the water W from the rear tank 22 to the left tank 24 as shown in FIG. 7B.

Here, in a case in which the radiation is coming from the direction of arrow Tin FIG. 1, the front tank 20 may shield the radiation in a wider range relative to the semiconductor devices 16 than the left tank 24. Thus, in a case in which the radiation is coming from the direction of arrow T in FIG. 1, the water level control unit 66 performs a process to transfer the water such that the front tank 20 is given priority. The prioritized transfer here means transferring the water W to the front tank 20 first or increasing the volume of the water transferred to the front tank 20 in a case in which the total volume of the water W stored in the front tank 20, the rear tank 22, the left tank 24, and the right tank 26 is insufficient to make the water levels in both the front tank 20 and the left tank 24 positioned in the incoming direction equal to or higher than the standard water level. It will be noted that the water level control unit 66 may also perform a process to transfer the water W simultaneously or equally to the multiple tanks positioned in the incoming direction irrespective of the total volume of the water W.

### (Operation and Effects of the Embodiment)

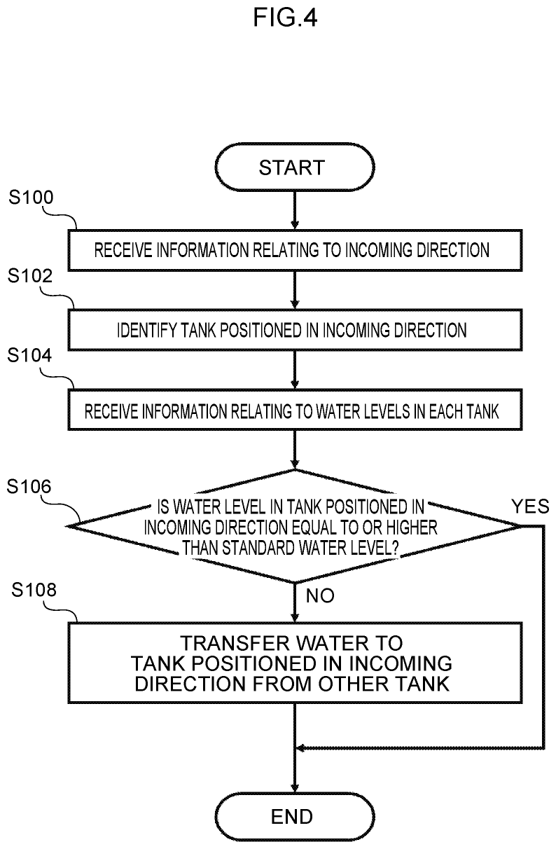

Next, a liquid level control process pertaining to the embodiment executed by the CPU 42 will be described using the flowchart of FIG. 4, and through this description the operation and effects of the embodiment will be described. The flowchart is executed as needed at, for example, timings when the rover 14 changes its traveling direction, timings when the water is discharged from the discharge portion 30, and at predetermined time intervals. It will be noted that the execution timings are not limited to the above.

In step S100 the CPU 42 receives from the four sun sensors 40 the information relating to the intensity and incoming direction of the sunlight measured by each of the sun sensors 40.

In step S102 the CPU 42 identifies the tank positioned in the incoming direction of the radiation relative to the semiconductor devices 16 based on the information relating to the intensity and incoming direction of the sunlight.

In step S104 the CPU 42 receives from the four water level sensors 38 the information relating to the water levels measured by each of the water level sensors 38 in the front tank 20, the rear tank 22, the left tank 24, and the right tank 26.

In step S106 the CPU 42 determines whether or not the water level in the tank positioned in the incoming direction is equal to or higher than the standard water level based on the information relating to the water levels in the front tank 20, the rear tank 22, the left tank 24, and the right tank 26.

In a case in which the CPU 42 determines in step S106 that the water level in the tank positioned in the incoming direction is equal to or higher than the standard water level, the CPU 42 ends the process without moving the water W.

In a case in which the CPU 42 determines in step S106 that the water level in the tank positioned in the incoming direction is lower than the standard water level, the CPU 42 moves to step S108.

In step S108 the CPU 42 controls the pumps 34 and the valves (not shown in the drawings) of the liquid transfer apparatus 32 to control the water levels in the front tank 20, the rear tank 22, the left tank 24, and the right tank 26 so that the water level in the tank positioned in the incoming direction rises. In other words, the CPU 42 injects the water W to the tank positioned in the incoming direction from another tank.

For example, in a case in which the radiation is coming from the front side of the rover 14, the CPU 42 transfers the water from the left tank 24 and the right tank 26 to the front tank as shown in FIG. 5B. At this time, the CPU 42 transfers the water until the water level in the front tank 20 reaches the target water level based on the information relating to the water level in the front tank 20, and then ends the process.

Because the amount of radiation from sunlight at the lunar surface is greater than the amount of radiation from sunlight on Earth, the semiconductor devices 16 installed in the rover 14 that travels on the lunar surface need to be radiation-resistant or protected. Furthermore, the mass of the rover 14 that travels on the lunar surface is directly linked to launch costs and mission feasibility.

According to the liquid level control apparatus 10 and the rover 14 pertaining to this embodiment, in a case in which, for example, the radiation is coming from the front side of the rover 14 as shown in FIG. 5A, the water level in the front tank 20 positioned in the incoming direction of the radiation relative to the two semiconductor devices 16 is raised. Specifically, the pumps 34 and the valves (not shown in the drawings) of the liquid transfer apparatus 32 are controlled by the water level control unit 66 so that the water W is transferred from the left tank 24 and the right tank 26 to the front tank 20. Thus, the radiation coming from the front side of the rover 14 is shielded by the water W stored in the front tank

Furthermore, in a case in which the radiation is coming from the left side of the rover 14 as shown in FIG. 6A, the radiation coming from the left side of the rover 14 is shielded by the water W stored in the left tank 24. Likewise, the radiation coming from the rear side of the rover 14 is sufficiently shielded by making the water level in the rear tank 22 equal to or higher than the standard water level, and the radiation coming from the right side of the rover 14 is sufficiently shielded by making the water level in the right tank 26 equal to or higher than the standard water level.

The solar elevation is low at the lunar polar regions P, so the radiation is always incident from a horizontal direction relative to the rover 14. Thus, by providing the front tank 20, the rear tank 22, the left tank 24, and the right tank 26 in the front, rear, left, and right directions of the rover 14 and controlling the water levels in each, the radiation is always shielded by at least one of the front tank 20, the rear tank 22, the left tank 24, and the right tank 26 even when the orientation of the rover 14 relative to the sunlight changes.

In this way, by controlling the water levels in the front tank 20, the rear tank 22, the left tank 24, and the right tank 26 provided around the semiconductor devices 16, shielding may be selectively enhanced relative to the incoming direction of the radiation as needed. For this reason, compared with a structure that always shields all sides of the semiconductor devices 16, the semiconductor devices 16 may be protected from the radiation with a lightweight structure. Because of this, the risk of degradation and failure of the devices caused by the total ionizing dose effect may be inhibited. Thus, according to the rover 14 pertaining to this embodiment, launch costs for a mission to explore the lunar surface may be reduced and mission feasibility may be improved.

Furthermore, as long as that the total volume of the water W stored in the front tank 20, the rear tank 22, the left tank 24, and the right tank 26 does not become a volume less than the standard water level in any of the tanks, protective walls that inhibit degradation of the semiconductor devices 16 may be formed. Thus, compared with a configuration where the water W is disposed on all sides of the semiconductor devices 16, the function of inhibiting radiation may be maintained with a small volume of the water W.

Moreover, even in a case in which the total volume of the water W stored in the front tank 20, the rear tank 22, the left tank 24, and the right tank 26 becomes less than the standard water level in one tank, by transferring the water W to the tank positioned in the incoming direction of the radiation, a maximum protective effect utilizing this water W may be obtained. In other words, the semiconductor devices 16 may be effectively protected even in a case in which, in an abnormal circumstance or the like, the water W may not be sufficiently ensured.

Moreover, according to the liquid level control apparatus 10 pertaining to this embodiment, in a case in which the water level in the tank positioned in the incoming direction relative to the semiconductor devices 16 is equal to or higher than the standard water level, the water W stored in the front tank 20, the rear tank 22, the left tank 24, and the right tank 26 is not moved. Thus, only in a case in which the water level in the tank positioned in the incoming direction is insufficient for obtaining a predetermined protective effect is the water W transferred to the tank positioned in the incoming direction. Thus, energy consumption pertaining to transfer is inhibited. Furthermore, the water W is transferred between the front tank 20, the rear tank 22, the left tank 24, and the right tank 26, so compared with a configuration that supplies the water W from a separately provided tank to the front tank 20, the rear tank 22, the left tank 24, and the right tank 26, the devices may be protected from the radiation with a simple configuration.

Furthermore, according to the liquid level control apparatus 10 pertaining to this embodiment, the radiation may be attenuated even in a case in which the radiation is coming from a direction straddling multiple tanks among the front tank 20, the rear tank 22, the left tank 24, and the right tank 26.

Moreover, the water W is transferred such that, among the multiple tanks positioned in the incoming direction, the tank that may shield the radiation in a wider range relative to the devices is given priority. Therefore, the semiconductor devices 16 may be efficiently protected from the radiation early on. Furthermore, even in a case in which there is not enough of the water W to make all the water levels in the front tank 20, the rear tank 22, the left tank 24, and the right tank 26 equal to or higher than the standard water level, the semiconductor devices 16 may be efficiently protected by an optimum arrangement of the water W.

Moreover, in a case in which the water level in at least one of the multiple tanks positioned in the incoming direction is lower than the standard water level, the water W is transferred to the tank whose water level is lower than the standard water level so that the water levels in all the tanks positioned in the incoming direction become equal to or higher than the standard water level. Thus, shielding relative to the semiconductor devices 16 is improved even more.

Furthermore, the front tank 20, the rear tank 22, the left tank 24, and the right tank 26 are provided in the end portions of the cabin 18 in the front and rear direction and left and right direction in which the radiation may come. For this reason, the radiation is shielded by at least one of the front tank 20, the rear tank 22, the left tank 24, and the right tank 26 positioned in the incoming direction, and ingress of radiation into the space inside the cabin 18 is inhibited. Thus, the two semiconductor devices 16 installed inside the cabin 18 are collectively protected without needing to provide a shielding member or a shielding apparatus for each of the semiconductor devices 16. Furthermore, the crew (not shown in the drawings) inside the cabin 18 may be protected from the radiation.

Moreover, by using the liquid transfer apparatus 32 to transfer the water W to the tank provided with the discharge portion 30, the water W stored in the front tank 20, the rear tank 22, the left tank 24, and the right tank 26 may be discharged from the discharge portion 30. Because of this, the water W stored in the front tank 20, the rear tank 22, the left tank 24, and the right tank 26 may be utilized as domestic water for the crew.

Moreover, the four substantially cuboidal tanks, the front tank 20, the rear tank 22, the left tank 24, and the right tank 26, are arranged substantially in the shape of a rectangle in plan view. Thus, compared with a case in which plural arc-shaped tanks are arranged in the shape of a circle, the walls of the tanks may be made thin, and a further reduction in weight may be achieved. Furthermore, the price of the tanks themselves may be kept down. Moreover, the tanks may be efficiently provided inside the rover 14 formed in a substantially cuboidal shape.

Furthermore, compared with a configuration where three substantially cuboidal tanks surround the semiconductor devices 16 substantially in the shape of a triangle in plan view, the devices may be effectively protected by a small volume of the water W and with efficient utilization of space. Moreover, compared with a case in which five or more tanks are provided, the semiconductor devices 16 may be protected with a simple configuration.

Moreover, compared with a configuration where, for example, plural tanks are fixed on a turntable and rotated around the semiconductor devices 16 to dispose a tank with a large residual volume of water in the incoming direction of the radiation, a rotational mechanism is not required. For this reason, even in a case in which the total volume of water becomes lower, the devices may be effectively protected. Moreover, compared with a configuration where one tank is fixed on a turntable and rotated around the semiconductor devices 16 to dispose the tank in the incoming direction of the radiation, the front tank 20, the rear tank 22, the left tank 24, and the right tank 26 may be efficiently installed in the rover 14 with a sufficient volume of water W needed during the mission dispersed between them.

### [Supplemental Description of the Embodiment]

In the above embodiment, the liquid level control apparatus 10 has been described as being installed in the rover 14 that travels in the lunar polar regions P, but the liquid level control apparatus 10 is not limited to this. For example, the liquid level control apparatus 10 may also be installed in a rover that travels in another region of the moon, and may also be installed in a vehicle that travels on Earth. Furthermore, the liquid level control apparatus 10 may also be installed in a moving body used, for example, in a nuclear power plant.

In the above embodiment, the water W that is domestic water for the crew (not shown in the drawings) has been described as being stored in the front tank 20, the rear tank 22, the left tank 24, and the right tank 26, but the liquid stored in the tanks is not limited to this, and another liquid containing hydrogen atoms may also be stored in the tanks.

Moreover, in the above embodiment, the water W has been described as being transferred between the front tank 20, the rear tank 22, the left tank 24, and the right tank 26, but the transfer is not limited to this. For example, a separate tank may be provided, and each of the front tank 20, the rear tank 22, the left tank 24, and the right tank 26 may be connected by the liquid transfer apparatus 32 to this separate tank.

Moreover, in the above embodiment, the liquid level control unit 66 has been described as performing control to transfer the water W to the tank positioned in the incoming direction from another adjacent tank, but it is not limited to this. For example, in a case in which the radiation is coming from the front of the rover 14, the liquid level control unit 66 may also perform control to transfer the water from the rear tank 22 via the left tank 24 or the right tank 26 to the front tank 20.

Furthermore, in the above embodiment, the four substantially cuboidal tanks, the front tank 20, the rear tank 22, the left tank 24, and the right tank 26, have been described as being arranged substantially in the shape of a rectangle in plan view, but the shape, number, and arrangement of the tanks are not limited to this. For example, the tanks may also be formed substantially in the shape of an L in plan view or in the shape of an arc in plan view. Furthermore, it suffices for the rover 14 to include two or more tanks. By providing three or more tanks, depending on the design the semiconductor devices 16 may be reliably protected even in a case in which the radiation is coming from a direction straddling multiple the tanks. Moreover, for example, the tanks may be disposed in the roof provided in the upper end portion or the floor provided in the lower end portion of a rover that travels outside the lunar polar regions P or a vehicle that travels on Earth.

Moreover, in the above embodiment, the water level control unit 66 has been described as not moving the water W in a case in which the water level in the tank positioned in the incoming direction relative to the semiconductor devices 16 is equal to or higher than the standard water level. The water level control unit 66 is not limited to this and may also, even if the water level in the tank positioned in the incoming direction is equal to or higher than the standard water level, perform control to transfer the water W until the water level reaches the target water level for example.

Moreover, in the above embodiment, the water W has been described as being transferred so that the water levels in all the tanks positioned in the incoming direction become equal to or higher than the standard water level, but the transfer of the water W is not limited to this. For example, in a case in which there are multiple tanks positioned in the incoming direction, it suffices for the water W to be transferred to at least one of the tanks. Because of this, a predetermined protective effect may be obtained even, for example, in a case in which there is not enough of the water W or a case in which one wishes to conserve transfer energy.

What is claimed is:

1. A liquid level control apparatus comprising:
a memory; and
a processor coupled to the memory and that is configured to:
receive information relating to an incoming direction of radiation; and
control, based on the received information relating to the incoming direction, liquid levels in a plurality of tanks that are provided around a device and that store a liquid, so that the liquid level in a tank positioned in the incoming direction relative to the device rises.

2. The liquid level control apparatus of claim 1, wherein the processor is configured to perform a process to transfer the liquid to the tank positioned in the incoming direction from another tank among the plurality of tanks, wherein the plurality of tanks are communicated to each other by pipes.

3. The liquid level control apparatus of claim 2, wherein the processor is configured to:
further receive information relating to the liquid levels in the plurality of tanks; and
perform a process of not moving the liquid stored in the plurality of tanks in a case in which the liquid level in the tank positioned in the incoming direction relative to the device among the plurality of tanks is equal to or higher than a standard liquid level, and transferring the liquid to the tank positioned in the incoming direction from another tank among the plurality of tanks in a case in which the liquid level of the tank positioned in the incoming direction relative to the device is lower than the standard liquid level.

4. The liquid level control apparatus of claim 3, wherein the processor is configured to perform a process to transfer, in a case in which there are multiple tanks positioned in the incoming direction relative to the device, the liquid to at least one of the tanks positioned in the incoming direction.

5. The liquid level control apparatus of claim 4, wherein the processor is configured to perform a process to transfer the liquid such that, among the multiple tanks positioned in the incoming direction, the tank that is able to shield the radiation in a wider range relative to the device is given priority.

6. The liquid level control apparatus of claim 4, wherein the processor is configured to perform a process to transfer the liquid so that the liquid levels in all of tanks positioned in the incoming direction become equal to or higher than the standard liquid level.

7. A moving body comprising:
the liquid level control apparatus of claim 1;
the device; and
the plurality of tanks.

8. A moving body comprising:
the liquid level control apparatus of claim 3;
direction sensors that detects the incoming direction;
the device;
the plurality of tanks;
liquid level sensors that detects the liquid levels in the plurality of tanks; and
liquid transfer apparatus that include the pipes and pumps and transfers the liquid between the plurality of tanks.

9. The moving body of claim 8, wherein the plurality of tanks are provided in end portions of a cabin, in which a plurality of the devices are installed, at least in directions in which there is a possibility that the radiation comes relative to the plurality of devices.

10. The moving body of claim 9, wherein the cabin is configured to be able to accommodate an occupant.

11. The moving body of claim 10, wherein at least one of the plurality of tanks includes a discharge portion that discharges the liquid to an exterior of the tank.

12. The moving body of claim 11, wherein the moving body is a rover that travels on the lunar surface.

13. The moving body of claim 12, wherein
the moving body is a rover that travels in the lunar polar regions, and
the plurality of tanks include a front tank provided in a front end portion of the rover, a rear tank provided in a rear end portion of the rover, a left tank provided in a width direction left end portion of the rover, and a right tank provided in a width direction right end portion of the rover.

14. A liquid level control method comprising:
receiving information relating to an incoming direction of radiation; and
controlling, based on the received information relating to the incoming direction, liquid levels in a plurality of tanks that are provided around a device and store a liquid, so that the liquid level in a tank positioned in the incoming direction relative to the device rises.

15. A non-transitory storage medium storing a program that causes a computer to execute a liquid level control process, the liquid level control process comprising:
receiving information relating to an incoming direction of radiation; and
controlling, based on the received information relating to the incoming direction, liquid levels in a plurality of tanks that are provided around a device and store a liquid, so that the liquid level in a tank positioned in the incoming direction relative to the device rises.
